(19) United States
(12) Patent Application Publication
(10) Pub. No.: US 2003/0097221 A1
(43) Pub. Date: May 22, 2003

(54) Detection and characterization of psychoactives using parallel multi-site assays in brain tissue

(76) Inventors: Daniel Chun, Cypress, CA (US); Jim Whitson, Irvine, CA (US); Gary Lynch, Irvine, CA (US)

Correspondence Address: Lisa A. Amii, Morrison & Foerster LLP, 755 Page Mill Road, Palo Alto, CA, 94304-1018, US

(21) Appl. No.: 10/271,487

(22) Filed: Oct. 15, 2002

Related U.S. Application Data
(60) Provisional application No. 60/329,085, filed on Oct. 12, 2001.

(51) Int. Cl. G06F 19/00

(52) U.S. Cl. 702/19

(57) ABSTRACT

This invention relates to methods and devices for the detection and characterization of psychoactive compounds by comparing electrophysiological responses from various regions in a neuronal tissue sample. In particular, electrophysiological responses are measured in parallel, i.e., simultaneously from multiple regions in one or more neuronal tissue samples.

### FIELD OF THE INVENTION

The present invention relates to a method and device for the detection and characterization of psychoactive compounds. Specifically, the detection and characterization of psychoactive compounds by simulataneously analyzing the electrophysiological response of various regions within a neuronal tissue sample is described.

### BACKGROUND OF THE INVENTION

There has been considerable effort to develop methods and devices for the characterization and detection of psychoactive compounds. Current electrophysiological methods for drug screening and/or drug development typically comprise gathering: 1) baseline cellular response values; 2) response data from the effect of washing in a test compound(s); and 3) response data from the effect of washing out the test compound(s). Such methods, when practiced in a neuronal tissue slice, usually gather response data from only a single location in the slice. All the data is collected sequentially at the singular site by stimulating and recording the resulting activity, then waiting for the tissue at the singular site to recover, and then repeating the protocol. Therefore, running multiple experiments typically requires using multiple tissue slices.

The disadvantages of such methods include: 1) only a single experiment per slice can be run because the slice will typically die before another experiment can be completed; 2) the tissue in the recording chamber contains many anatomically and pharmacologically distinct regions that are not monitored for response data even though the compound(s) is being applied to all regions of the tissue slice; and 3) cellular activity measures from one slice to the next, as is well known in the art, can vary significantly.

A further problem encountered in the art has been the low predictive value of current psychoactive compound testing methods. Psychoactive compounds have a relatively small probability of affecting the activity of a single neuron or even small groups of neurons in the same way that they might affect networks of neurons and/or global processes within the brain. Although there may be compound-induced changes at the limited levels of observation currently achieved in the art, such changes may be just part of a complex response that such compounds ellicit across brain regions and systems. If the activity of compounds were assayed in distinct anatomical and pharmacological regions, then the predictive value of such activities, as they relate to brain activity, would likely be enhanced. However, many in vivo or in vitro models lack some or all of these important features.

A difficulty encountered in the art of psychoactive compound testing is that such regional activity monitoring is not practical. Further, even extant methods which attempt to look at different neuronal regions are hampered by the fact that multiple brain slices must be employed, and such slices can greatly differ in their physiological responsiveness. This variability serves to confound meaningful results.

None of the cited documents discuss assay systems that can produce the enhanced diagnostic characteristics, and improved detection attributes, mentioned above, and new ways to investigate psychoactive compounds.

### SUMMARY OF THE INVENTION

The present invention provides methods and devices for the detection and characterization of psychoactive compounds by measuring and comparing electrophysiological response parameters simultaneously from multiple regions of an in vitro neuronal tissue sample.

In one variation, the method for the detection and characterization of a psychoactive compound in an in vitro neuronal tissue sample includes the steps of: 1) simultaneously measuring a baseline electrophysiological parameter at a plurality of regions in the in vitro neuronal tissue sample; 2) contacting the in vitro neuronal tissue sample with a candidate sample composition; 3) measuring a resulting electrophysiologial response parameter in the in vitro neuronal tissue sample; and 4) comparing the resulting electrophysiological response parameter with the baseline electrophysiological parameter to detect the presence or absence of the psychoactive compound in the candidate sample composition. The baseline electrophysiological parameter may include extracellular voltage or oscillations of extracellular potential. Additionally, the oscillations may be spontaneous or induced.

In the variation using induced oscillations, the oscillations may be induced by chemical compositions that tend to induce neuronal activity in in vitro neuronal tissue samples. These compositions include those that facilitate, mimic, inhibit, enhance, or modulate the activities triggered by endogenous neurotransmitters such glutamate, acetylcholine, dopamine, serotonin, opioids, nitric oxide, GABA, catecholamines, and the like, in neuronal tissue. However, other stimulations are acceptable. For example, oscillations may be induced by co-deposited neuronal tissue or delivered electrical pulses.

In another variation, at least one timed electrical pulse is delivered to one or more regions in the in vitro neuronal tissue sample. The pulse, when sequentially delivered at appropriate times and locations, triggers the various electrophysiological parameters in the tissue. The in vitro sample is then typically brought into contact with a candidate sample composition having a psychoactive compound or compounds. Another timed pulse may then optionally be delivered. Coincidentally with (or subsequent to) introduction of the candidate sample, an array of extracellular paramters, e.g., voltage, potential values, and/or other electrophysiological activities, are measured. The sets of data can then be rendered to produce so-called “calculated values.” Comparing the data and/or calculated values will then allow detection, characterization of the pharmacological activity, and determination of the mechanism of action and/or other salient features of such psychoactive compounds in the sample should one or more be present.

It is also desirable to use a multi-electrode dish (“MED”) so that a number of different active or less active sites on the neuronal sample may be simultaneously or sequentially sampled. Use of the MED permits measurement and calculation of spatial relationships; both measured and calculated, amongst the values and measures of the neural activity. The multi-electrode nature of the MED also enables the determination and characterization of region-specific effects within the given in vitro neuronal sample.

Appropriate mathematical analysis of any oscillations of extracellular voltage can include a Fast Fourier Transform (FFT) of oscillations measured at a single spatial point to enhance differences in amplitude and frequency of the before-and-after single-site measurements.

Similarly, the sequence of oscillations of extra-cellular voltage obtained in an array as a function of time may be subjected to Current Source Density (CSD) analysis to produce and depict current flow patterns within the in vitro neuronal tissue sample.

Additionally, the neural activity can be analyzed by separating the waveforms into fast and slow components and calculating local maxima and minima, decay time, and the like.

Another portion of the method includes: 1) the use of tissue preparation methods that preserve regional structures, 2) electrical stimulation patterns that tend to stimulate or induce salient neuronal responses, characterized by sustained time courses and distributed activity of neurons across brain tissue regions.

Yet another portion of the method includes the in vitro measurement of muscle electrical activity. Muscle, in the same manner as neuronal tissue, exhibits spontaneous electrical waveforms and is “excitable.” Changes in the electrical activity pattern of muscle, e.g., smooth muscle, thus may also be used to detect and characterize psychoactive test compound compositions, similar to the processes and methods herein described for in vitro neuronal tissue samples.

### BRIEF DESCRIPTION OF THE DRAWINGS

FIG. 1 shows a version of the apparatus used for stimulating and recording from tissue samples.

FIG. 2 shows an arrangement of electrodes in the recording chamber and a hippocampal brain slice in position to be recorded.

FIG. 3 is a schematic representation of recording and stimulation electrodes.

FIG. 4 is a flow chart depicting how the computer controls the interleaved execution of multiple experiments.

FIG. 5 shows the effects of AMPA receptor modulator CX516 on paired-pulse fEPSP responses in different areas of hippocampus.

FIG. 6 shows how glutamate receptor-mediated evoked excitatory synaptic transmission is modulated by ampakine CX516 (1-(Quinoxalin-6-ylcarbonyl)piperidine) in different areas of hippocampus.

FIG. 7 shows the effects of AMPA receptor modulators CX516, CX546 and CX554 on paired-pulse fEPSP responses in different areas of hippocampus.

FIG. 8 shows how glutamate receptor-mediated evoked excitatory synaptic transmission is modulated by CX546 in different areas of hippocampus.

FIG. 9 shows the effects of AMPA receptor modulators CX516, CX546, and CX554 on paired-pulse fEPSP responses in different areas of hippocampus.

### DETAILED DESCRIPTION

Recited is a process and device for the detection and/or characterization of psychoactive compounds using measurements of regionally-distinct extracellular voltage (potential) in in vitro neuronal tissue samples. The measurement of extracellular potentials in in vitro neuronal tissue over the spatial array of a neuronal sample may be found in the various descriptions of such devices found in U.S. Pat. Nos. 5,563,067 and 5,810,725 to Sugihara et al., the entirety of which are incorporated by reference. Additional details relating to the devices, methods, and processes herein described may also be found in U.S. patent application Ser. Nos. 09/602,629 and 60/329,011 which are herein incorporated by reference in their entirety.

Definitions

As used herein, the term “hippocampus” refers to a region of the telencephalon that is located behind the temporal lobes and has been implicated in memory formation and retrieval in humans and other animals.

As used herein, the term “hippocampal slice” refers to a physical slice of hippocampal tissue approximately 100-500 micrometers in thickness that can be used on the electrophysiological recording apparatus described herein.

As used herein, the terms “CA1”, “CA2”, “CA3”, and “CA4” refer to one of four regions of hippocampus.

As used herein, the term “dendrites” refers to the highly branched structure emanating from the cell body of the nerve cells.

As used herein, the terms “Schaffer collateral” and/or “Schaffer commissural” refer to the axonal pathway connecting CA3 and CA1 pyramidal cells. As used herein, the term “regional response” refers to a response generated by a specific area of the tissue sample.

The terms “baseline electrophysiological parameter” or “baseline parameter” as used herein refer to a parameter that is measured prior to contact of neuronal tissue sample with a candidate sample composition. Examples of a baseline parameters are extracellular voltage and oscillations of extracellulular potentials.

The terms “electrophysiological response parameter” or “response parameter” as used herein refer to a parameter that is measured after contact of a neuronal tissue sample with a candidate sample composition.

Measuring Apparatus

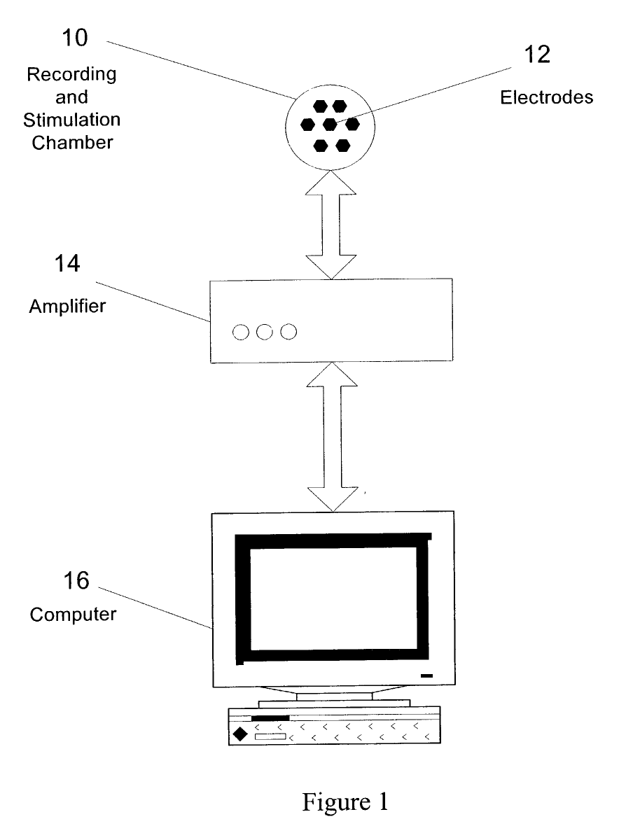

In one variation, the measuring apparatus component of this invention is a computer-controlled multi-electrode recording and stimulation array. The large-scale design of such a system is summarized in FIG. 1. As shown in FIG. 1, the system includes a multi-electrode recording and stimulation chamber 10, an amplifier 14, and a computer 16. The recording and stimulation chamber or dish 10 contains a plurality of electrodes 12. This dish holds the neuronal sample under study as well as fluids, e.g., artificial cerebrospinal fluid, to keep the the neuronal sample alive. The chamber 10 is connected to an amplifier 14 via a connector that can pass signals both to and from the chamber and its electrodes. The amplifier is connected to a computer 16 via a bi-directional connection. The computer contains an analog to digital converter with sufficient versatility to record from any of the electrodes in the dish. The computer is able to stimulate any of the electrodes in the dish, and possesses software that enables the pre-programming and execution of complex stimulation and electrode switching patterns.

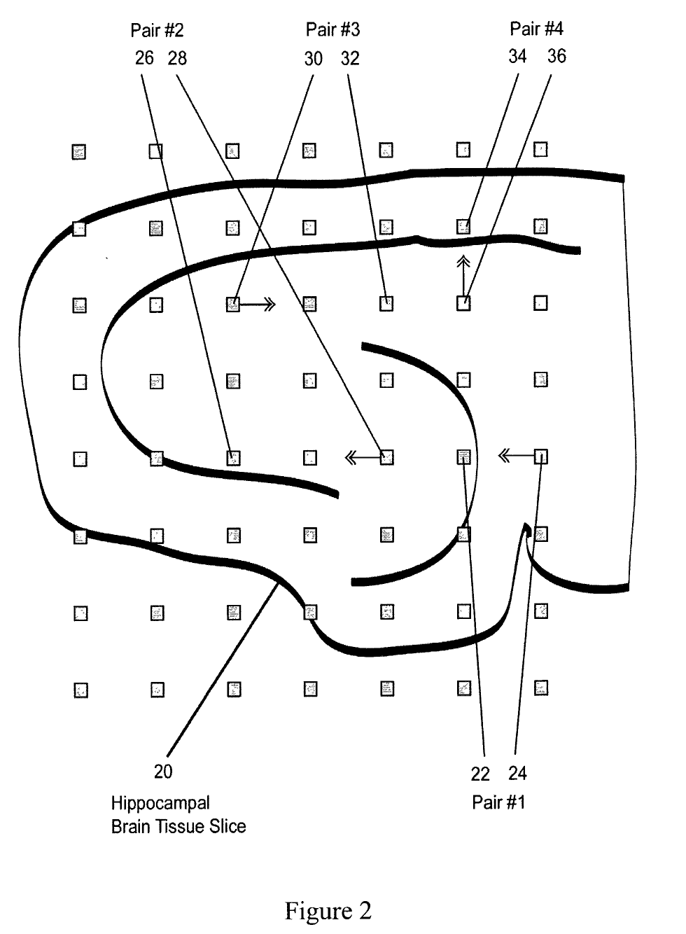

An enlarged view of the stimulation and recording chamber is shown in FIG. 2. In FIG. 2, a hippocampal brain slice 20 is shown resting on a grid of electrodes. Four pairs of electrodes (22 and 24; 26 and 28; 30 and 32; 34 and 36) have been selected for use. Electrodes 24, 28, 30, and 36 are used to stimulate axonal projections in the direction indicated by the arrows attached to each of these electrodes. The other four electrodes 22, 26, 32, and 34 are used to record the activity generated by the stimulation electrodes.

The cell potential measuring electrode array preferably used with this inventive process includes a plurality of measurement electrodes on an insulating substrate, a conductive pattern for connecting the microelectrodes to some region out of the microelectrode area, electric contacts connected to the end of the conductive pattern, an insulating film covering the surface of the conductive pattern, and a wall enclosing the region including the microelectrodes on the surface of the insulating film.

The array also includes a plurality of reference electrodes that may have comparatively lower impedance than the impedance of the measuring microelectrodes. The reference electrodes may be placed at various positions in the region enclosed by the wall and often at a specific distance from the microelectrodes. Furthermore, the electric contacts are usually connected between the conductive pattern for wiring of each reference electrode and the end of the conductive pattern. The surface of the conductive pattern for wiring of the reference electrodes is typically covered with an insulating film.

Typically, the microelectrodes are situated in a matrix arrangement in a rectangle having sides of, e.g., 0.8 to 2.2 mm (in the case of 300 micrometer microelectrode pitch) or 0.8 to 3.3 mm (in the case of 450 micrometer microelectrode pitch). Four reference electrodes are situated at four corners of a rectangle of 5 to 15 mm on one side. More preferably, 64 microelectrodes are situated in eight rows and eight columns at central pitches of about 100 to 450 micrometers, preferably 100 to 300 micrometers. Preferably, the microelectrodes and the reference electrodes are formed of layers of nickel plating, gold plating, and platinum black on an indium-tin oxide (ITO) film.

The insulating substrate (e.g., a glass substrate) may be nearly square. Plural electric contacts may be connected to the end of the conductive pattern and preferably are placed on the four sides of the insulating substrate. As a result, layout of wiring patterns of multiple microelectrodes and reference electrodes is simple. Because the pitches of electric contacts may be made to be relatively large, electric connection through the electric contacts with external units is also simple.

The microelectrode region is usually very small. When observing the sample through a microscope, it is hard to distinguish position and both vertical and lateral directions. It is desirable to place indexing micro-marks near the microelectrode region to allow visual recognition through the microscope variously of direction, axes, and position.

It is even more preferable to perform the following sequence of events to determine electrode positions versus the anatomical correlates of the in vitro neuronal samples: 1) placing a control in vitro neuronal sample on the array in order that the array can cover the important area of the sample; 2) taking a picture of the control sample on the array; 3) recording the electrical activity from the control sample; 4) placing a test sample on the array in the same relative position as the control sample as accurately as possible; 5) taking a picture of the test sample on the array; 6) recording the electrical activity from the test sample; 7) comparing the control picture and the test picture; and 8) comparing the electrical activity from the control and test samples.

An alternative method is to use an object recognition algorithm (where the object is the gross anatomical structure of the in vitro neuronal sample) to compare object recognition algorithm data, and compare the electrical activity from the control and test samples.

In another variation, the cell potential measuring apparatus is made up of a cell placement device having cell potential measuring electrodes, contact sites for contacting with an electric contact, and an electrode holder for fixing the insulating substrate by sandwiching from above and beneath. The cell potential measuring electrodes may be connected electrically to the cell placement assembly device to allow processing of the voltage or potential signals generated by the sample and measured between each such microelectrode and the reference electrodes. The cell potential measuring assembly may include a region enclosed by a wall for cultivating sample neuronal cells or tissues. It may also include an optical device for magnifying and observing optically the cells or tissues cultivated in the region enclosed by the wall. This cell potential measuring apparatus may also further include an image memory device for storing the magnified image obtained by the optical device.

In general, a personal computer, or other form of digital controller, having installed measurement software, is included to accept the measured cell potentials. The computer and cell placement device are typically connected through an I/O board for measurement. The I/O board includes an A/D converter and a D/A converter. The A/D converter is usually for measuring and converting the resulting potentials; the D/A converter is for stimulus signals to the sample, when needed.

The measurement software installed in the computer may include software for setting conditions for giving a stimulus signal, forming the stimulus signal, and for recording the obtained detection signal from the neuronal cells or tissue slice. The computer may also control any optical observation devices (SIT camera and image memory device) and the cell culture system.

In one variation, the extracellular potential detected from the cells may be displayed in real time. In another variation, the recorded spontaneous electrical activity or induced potential desirably is displayed by overlaying the waveform recordings on the microscope image of the cell. Alternative variations include software with image processing capabilities, e.g., feature recognition, edge detection, edge enhancement, or algorithmic capabilities. When measuring the potential, the entire recorded waveform is usually displayed visually and then correlated to the position of the waveform in the neuronal sample.

When a stimulus signal is issued from the computer, this stimulus signal is sent to the cell placement device through a D/A converter and an isolator. The cell placement device includes a cell potential measuring electrode that may be formed, e.g., of 64 microelectrodes on a glass substrate in a matrix form and having an enclosing wall for maintaining the neuronal sample (e.g., segments of cells or tissues) in contact with the microelectrodes and their culture fluid. Preferably, the stimulus signal sent to the cell placement device is applied to arbitrary electrodes out of the 64 microelectrodes and then to the sample or samples.

The induced (evoked) or spontaneous potential occurring between each microelectrode and reference potential (which is at the potential of the culture fluid) is passed through a 64-channel high sensitivity amplifier and an A/D converter into the computer. The amplification factor of the amplifier may be, e.g., about 80-100 dB, for example, in a frequency band of about 0.1 to 10 kHz, or to 20 Hz. However, when measuring the potential induced by a stimulus signal, by using a low-cut filter, the frequency band is preferably 1 Hz to 20 kHz.

In another variation, the apparatus includes a cell culture system having a temperature controller, a culture fluid circulation device, and a feeder for supplying, e.g., a mixed gas of air and carbon dioxide. The cell culture system may be made up of a commercial microincubator, a temperature controller, and CO₂ cylinder. The microincubator can be used to control in a temperature range of 0° C. to 50° C. by means of a Peltier element and is applicable to the liquid feed rate of 3.0 ml/min or less and gas flow rate of 1.0 liter/min or less. Or, alternatively, a microincubator incorporating a temperature controller may be used.

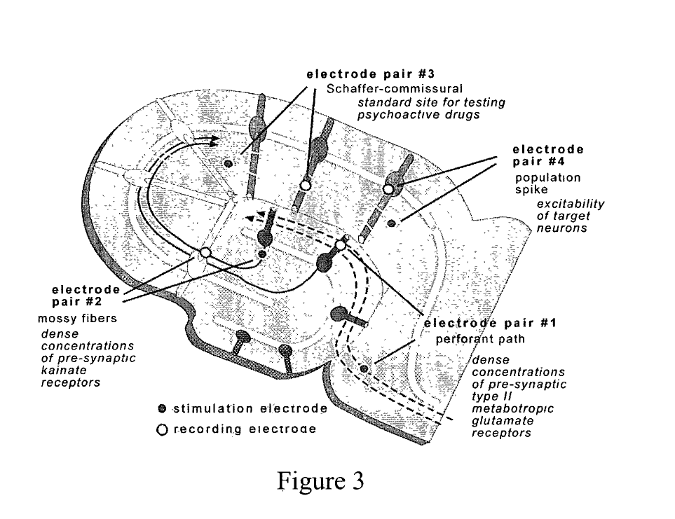

In yet another variation, the measuring apparatus uses multiple pairs of stimulation and recording electrodes in the recording chamber as shown in FIG. 3. These conventional glass electrodes are placed at various locations throughout the slice. This version of the recording chamber operates in conjunction with computing hardware in the same way as the multi-electrode array. The main difference between the two approaches lies in the practical limits placed on the number of electrodes that can be used—only a small number, perhaps three pairs (six total electrodes), are feasible with conventional glass electrodes. However, this is enough to implement the stimulation and recording methods of the instant invention.

Single Assay Data Measurement and Analysis

In general, the processes and methods described herein include the simultaneous measurement and recording of the electrical activity of neuronal samples both spatially and temporally at multiple measurement sites. Additionally, they include observing the extracellular voltage, potential values, or other electrophysiological measures at each of the measurement sites in the spatial array. Furthermore, the processes and methods include viewing the placement and the inherent physical boundaries of the neuroanl tissue sample (margins be correlated to the position of the sensors) using such instruments as optical devices or electronic sensing devices, or other devices which may be appreciated by one of skill in the art.

In use, the neuronal tissue sample is placed upon the in vitro cell potential measuring electrode array and procedures that would be known to one skilled in the art are used for maintaining its viability during the testing. The neuronal sample may be cultured, if desired. Typical procedures are discussed below with respect to the Examples. Each of the targeted microelectrodes is monitored, both as a function of time and as a function of frequency, and for activity triggered by stimulation and/or from the induction of psychoactive material. This produces an array of frequency, amplitude, extracellular voltage, potential values, and other electrophysiological measures as a function of time.

We have found it desirable to induce or stimulate oscillations of extracellular voltage or potential variously by chemical, physiological, or anatomical methods. In one variation, neuronal tissue is contacted with a chemical composition including, e.g., one or more compounds that facilitate, mimic, inhibit, stimulate, enhance, or otherwise modulate the activities triggered by endogenous neurotransmitters such as glutamate, acetylcholine, dopamine, serotonin, opioids, nitric oxide, GABA, catecholamines, and the like, in brain tissue. However, oscillations induced by co-deposited neuronal tissue, electrical stimulations, or other methods are acceptable.

We have also found it desirable to induce or stimulate neuronal responses by triggering changes in the spontaneous or induced oscillations of extracellular voltage or potential in neuronal samples using various timed physiological stimulation patterns. In one variation, timed physiological stimulation to localized regions of the tissue sample is used, e.g., to perforant path, mossy fibers, or Schaffer commissural regions.

In one variation, once a timed electrical pulse is delivered to an in vitro neuronal sample exhibiting spontaneous or induced oscillations, a set of baseline electrophysiological parameters, e.g., extracellular voltage, potential values, and the like, is measured. A candidate sample composition that may or may not contain a psychoactive compound is then contacted with the in vitro neuronal sample. An array of electrophysiological response parameters, e.g., extracellular voltage, potential values, and the like, is then measured. Detection and characterization of a psychoactive compound in the candidate sample composition may then be assessed by comparing the electrophysiological baseline parameters to the electrophysiological response parameters and detecting a difference between the baseline and response parameters. In yet another variation, a timed electrical pulse is not delivered to the neuronal sample prior to contacting it with a candidate sample composition.

Multiple Assay Data Measurement and Analysis

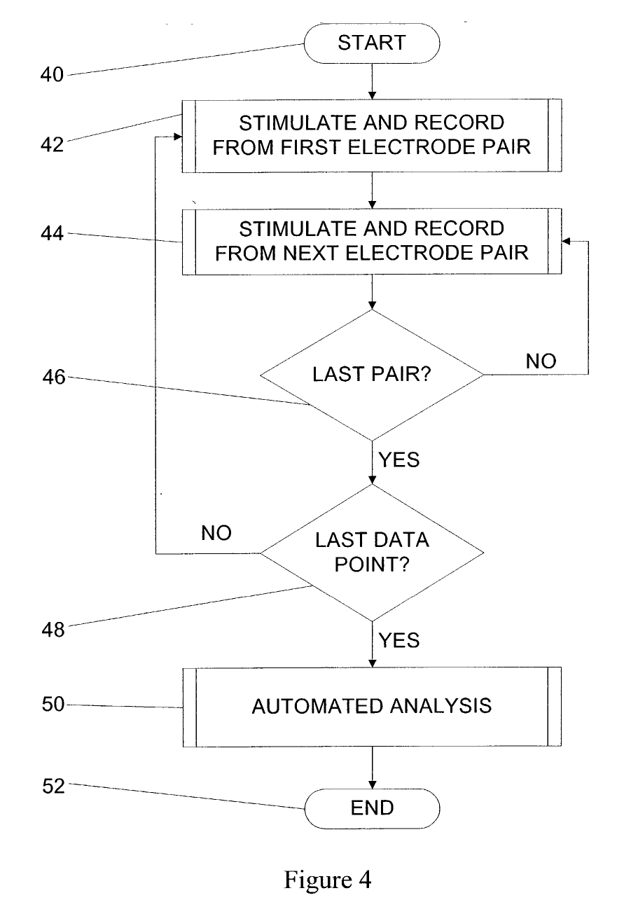

The instant invention utilizes a site-switching control program to run multiple assays in parallel by interleaving the stimulation and recording that takes place at each site. FIG. 4 demonstrates the computer process for controlling the execution of multiple interleaved assays. For example, an experiment testing a candidate sample composition would gather baseline data, wash-in data, and washout data at each site according to the procedures already described for a single site. Many variations are possible, but typically, the data gathering process presented in FIG. 4 is the same.

The “start” state 40 begins with the execution of the “stimulate and record from the first electrode pair” process 42. This process delivers a stimulation pattern (typically a waveform(s)) to the stimulating electrode 24 which can take various forms. The choice of stimulation pattern is made based upon the type of information that one desires to gather in the brain region of interest. Typically, with hippocampal tissue, various forms of paired-pulse stimulation are used that vary primarily in the delay between pulses (e.g., two short pulses spaced by 50 ms or 200 ms). The recording electrode 22 is selected in the region of interest such that stimulation events at the stimulation site 24 activate neurons in the region of interest via axonal pathways running between the two. The result of a single stimulation event is the recording of a single waveform response or “data point” by the computer. In the case of the “stimulate and record from the first electrode pair” process 42, the system typically only gathers a single data point from the first electrode pair 22 and 24.

Next, the process continues to the “stimulate and record from the next electrode” step 44. This step stimulates and records from the next electrode pair 26 and 28, gathering a new data point from them. Having gathered a new data point, the process moves on to the “last pair?” step 46. This step ensures that a single data point is gathered from each of the recording sites by looping up to the previous process 44 until it reaches the last electrode pair. When the last pair is reached, the next step, “last data point?” 48 confirms if this is the last data point to be gathered per site-specific experiment, and if it is not, then the computer program passes control back up to the “stimulate and record from the first electrode pair” process 42, and another round of samples are taken from the various recording sites.

Upon gathering the last data point from each site, the “automated analysis” process 50 executes. This process can perform a number of tasks. For example, it can determine specific features of waveforms, such as amplitude, slope, and area for each site under study and plot how such characteristics change during the course of the experiment. Such feature changes across the various regions of the slice can be used to predict the possible mechanisms of action for a compound. Such predictions can be determined by applying a set of expert system rules.

When using multiple interleaved assays it is important to consider certain factors. For example, the ability to use interleaving to run multiple assays in much less time than it takes to run them sequentially is possible only for experiments that require a delay between stimulations delivered at a particular site. Thus, in the case of the hippocampus, one typically allows about twenty seconds for recovery. During those twenty seconds all the other sites of interest are stimulated, and no site receives repeat stimulation in less than twenty seconds. In addtion, pharmacologically distinct regions must be stimulated with a variety of stimulation patterns to predict the mechanisms of action for a given compound. In the case of hippocampus, stimulation of the dentate gyrus, CA3, and CA1 using various forms of paired pulse stimulation provides a rich data set to enable such predictions. For example, a strong CA3 response can indicate that the test compound activates kainate receptors.

Other variations of the invention may be used, such as: 1) the number of electrodes and their arrangement in the stimulation and recording chamber can be varied (e.g., using a larger grid for larger brain slices); 2) the number of electrodes used for recording in association with a given stimulation event can be greater than one (e.g., stimulate the mossy fibers and record from all the electrodes in CA3); 3) more than one stimulation electrode can be used per site (e.g., stimulating CA3 using both perforant path and mossy fiber stimulations at once); 4) the number of sites visited in a given cycle can be varied as desired (e.g., instead of four electrode pairs as in FIG. 2 one could have six or eight); and 5) tissue slices from any type of nervous tissue can be used in place of hippocampal slices (e.g., cortical, striatal, retinal).

A further variation relates to the use of tissue in the recording and stimulation chamber. In this variation, it is possible to place more than one tissue sample in the chamber at once. If all the tissue samples are from the same brain area, for example, hippocampus, as discussed above, then one can run the interleaved stimulation paradigm on each tissue sample in parallel. This will allow for stimulation at multiple sites, each on a different tissue sample, whereas the method outlined in FIG. 3 showed the process where a single site was stimulated at a time. This variation multiplies the amount of data being gathered in one experiment by the number of tissue samples—the added data provides multiple examples of the same assay results. However, if the various tissue samples are taken from different brain regions then one is multiplying the variety of results being gathered, which in turn provides more information for making predictions about the mechanism of action. For example, one might test a striatum slice to observe the dopamine-related effects of a compound and the hippocampus to observe kainite-related effects.

Yet another variation of this invention replaces the automation of the control program with a clustering and/or classification system. In this variation, the features measured from the various brain regions are combined to form vectors, and these vectors are then clustered and/or classified using standard approaches to sort them into meaningful groups. Clustering is used to create groupings of compounds based upon characteristics, thus enabling the differentiation of similar compounds. Classification can be used to predict compound therapeutic effects and side effects by creating a database of feature vectors for compounds with known effects, then testing and classifying unknown compounds against the database of “standards.”

In general, characterization of the psychoactive compound in a candidate sample composition usually occurs by forming a data set having a format that allows later identification of a specific psychoactive compound. The format of the data set is generally created to include measurements of various electrophysiological parameters, e.g., frequency or amplitude, of oscillations generated by in vitro neuronal tissue samples contacted with known psychoactive compounds. Upon contact of an in vitro neuronal tissue sample with an unknown psychoactive compound, the electrophysiological parameters of the resulting response are compared with the electrophysiological parameters from the data set. The unknown psychoactive compound is then characterized by matching its electrophysiological parameters to those of known psychoactive compounds in the data set.

### EXAMPLES

The following Examples show the effects of psychoactive compounds on hippocampal tissue by performing several physiology tests on a single slice in parallel. Those skilled in the art will recognize that while specific embodiments have been illustrated and described, various modifications and changes may be made without it departing from the spirit and scope of the invention.

### Example 1

### Preparation of Multi-Electrode Array

Procedures for the preparation of the Multi-Electrode Dish (Panasonic: MED probe) are described by Oka et al. (1999). The device has an array of 64 planar microelectrodes, each having a size of 50×50 μm, arranged in an 8 by 8 pattern. Probes come with three types of interpolar distance, 150 μm, 300 μm, and 450 μm (Panasonic: MED-P515AP, MED-P530AP, MED-P545AP).

For sufficient adhesion of the slice to the probe, the surface of the MED probe was treated with 0.1% polyethylenimine (Sigma: P-3143) in 25 mM borate buffer, pH 8.4, for 8 hours at room temperature. The probe surface was rinsed 3 times with sterile distilled water. The probe (chamber) was then filled with DMEM/F-12 mixed medium, containing 10% fetal bovine serum (GIBCO: 16141-079) and 10% horse serum (GIBCO: 16050-122), for at least 1 hour at 37° C. DMEM/F-12 mixed medium is a 1:1 mixture of Dulbecco's Modified Eagle's Medium and Ham's F-12 (GIBCO: D/F-12 medium, 12400-024), supplemented with N₂ supplement (GIBCO: 17502-014) and hydrocortisone (20 nM, Sigma, H0888).

### Example 2

### Preparation of Hippocampal Slices

A 17-24 day old Sprague Dawley rat was decapitated after anesthesia with halothane (2-bromo-2-chloro-1,1,1-trifluoroethane; Sigma; B4388), and the whole brain was removed. The brain was immediately soaked for ˜2 min in ice-cold, oxygenated preparation buffer of the following composition (in mM): 124 NaCl, 26 NaHCO3, 10 glucose, 3 KCl, 1.25 NaH2PO4, 2 CaCl2, and 2 MgSO4. Appropriate portions of the brain were trimmed and placed on the ice-cold stage of a vibrating tissue slicer (Leica, Nussloch, Germany; VT-1000S). The stage was immediately filled with both oxygenated and frozen preparation buffers. The thickness of each tissue slice was 350 μm. Each slice was gently taken off the blade, and immediately soaked in the oxygenated artificial cerebrospinal fluid (ACSF) for at least 1 hr at room temperature. Then a slice was placed on the center of the MED probe. The slice was positioned to cover the 8×8 array. After positioning the slice, the MED probe was immediately placed in a box filled with 95% O₂ and 5% CO₂.

### Example 3

### Solutions and Chemicals

During recording, the slices were continuously perfused with a solution of the following composition: ACSF (in mM): 124 NaCl, 26 NaHCO3, 10 glucose, 3 KCl, 1.25 kH2PO4, 2 CaCl2, 1 MgSO4. All compounds were bath applied at known concentrations and were prepared daily from frozen aliquots. Compounds were purchased from Sigma. Ampakines (CX516, CX546, CX554) were made fresh everyday, and used at concentrations: CX516, 250 μM; CX546, 250 μM; and CX554, 30 μM.

Baseline, application, and recovery time was usually at 10, 20, and 30 min respectively.

### Example 4

### Electrophysiological Recording

During electrophysiological recording, the slices on the MED probe were placed in a small CO₂ incubator (Asahi Lifescience; model 4020) at 32° C. The slices were placed on an interface, and a moisturized with a 95% O₂ and 5% CO₂ gas mixture.

Evoked field potentials at all 64 sites (minus stimulation sites) were recorded simultaneously with the multichannel recording system (Panasonic: MED64 system) at a 20 kHz sampling rate. In the case of the evoked response, one of the planar microelectrodes out of the 64 available was used for the stimulating cathode. Bipolar constant-current pulses (10-50 μA; 0.1 ms) were produced by the data acquisition software via the isolator. The stimulating microelectrode was selected by the 64-switch box.

### Example 5

### Data Collection

Conventional neuronal tissue slice physiology typically employs a single stimulation electrode to elicit a response from the slice, and a single recording electrode to measure it. Usually, an experiment testing a candidate sample composition will focus on gathering data from a single location in a slice. Typically, a long sequence of stimulations will be delivered to establish baseline behavior (baseline electrophysiological parameters). A candidate sample composition having a psychoactive compound(s) is then applied to the slice, and optionally, another long sequence of stimulations is delivered in an attempt to reveal compound-induced alterations of responses. Even though the compound is distributed throughout the slice, only the one location is typically studied because moving the conventional electrode placements to new locations is a difficult and time-consuming process, and it is quite likely that the slice will die before multi-site data can be gathered.

A multi-electrode system, like the MED64, has the neuronal tissue slice resting upon an electrode grid or matrix, with each electrode capable of either stimulating or recording. Software that controls this grid enables a researcher to quickly choose any electrode for stimulation and/or recording. Consequently, changing stimulation and/or recording test sites for a candidate sample experiment is quick and simple. However, the switching process must be organized carefully to complete multiple experiments at multiple sites.

One way to organize the testing of multiple sites is to gather all of the baseline parameters for a given site, move to another, then gather all of the baseline parameters for that site, and so on—once all of the baseline parameter readings have been taken, a compound is applied, and the response parameters measured at each site. A problem encountered with this approach is that it takes so long to test even a small number of sites that the slice is likely to die before the experiment completes. One solution to this problem, as outlined above, lies in recognizing that the long recovery time between stimulations at a particular site (typically 20 seconds) can be used to perform stimulations at other sites in an interleaved manner. This means that the first site is stimulated, then the second, then the third, and so on until all the sites of interest have been stimulated once and a single measurement has been recorded from each of them. This cycle of site stimulations is repeated to completion of the experiment with each iteration adding a single new data point to record of a baseline paramter and a compound effect (response parameter) at each site. By making the round-trip time for the site stimulation cycle equal to or greater than the recovery time, each site is given sufficient time to recover between stimulations, while at the same time running multiple experiments in parallel at multiple sites for same amount of time it takes to run one conventionally (one schematic utilizing hippocampal brain tissue is presented in FIG. 4).

### Example 6

### Calculations

All assays employ paired-pulse stimulation at various rat hippocampal sites to elicit evoked responses. The resulting field EPSP recordings were analyzed using Matlab software (The MathWorks, Inc.) by computing several response measures such as amplitude, halfwidth, and negative area, which apply to both the first and second evoked reponses. Amplitude was defined as the maximum depolarization magnitude relative to the average baseline reading prior to the first stimulation pulse. Halfwidth was defined as the duration of the depolarization phase of the evoked response at half its maximum amplitude value. Negative area was obtained by taking the magnitude of the integral of the evoked response curve over all segments with the same polarity as the depolarization phase. This integral spans a time window of 25 msec beginning one msec after the stimulation pulse.

The polarity of the evoked responses for assay DG50 was reversed before analysis because of the inverted voltage values recorded by the DG50 electrode. Assays SC50, SC200, MF50, and CA3-1_{—}50, however, were analyzed without such a reversal.

Amplitudes and halfwidths for both first and second elicited responses were computed for assays SC50, SC200, and CA3-1_{—}50. For DG50 only first and second amplitudes were computed. Negative areas for first and second responses were computed for SC50, SC200, CA3-1_{—}50, and MF50.

All response paramters were utilized to quantify candidate sample composition effects on the hippocampus. For a given response parameter, the candidate sample composition effect was defined as the percent change of the average measure during the last five minutes of the wash-in phase with respect to the average measure of the last five minutes of the preceding, pre-wash-in control phase. Drawing conclusions of the effects of various candidate sample compositions involves comparing the various sample composition effect values over all response measures and assays using Matlab, Igor (WaveMetrics, Inc.), and Excel (Microsoft Corporation) software.

### Example 7

### Response Results

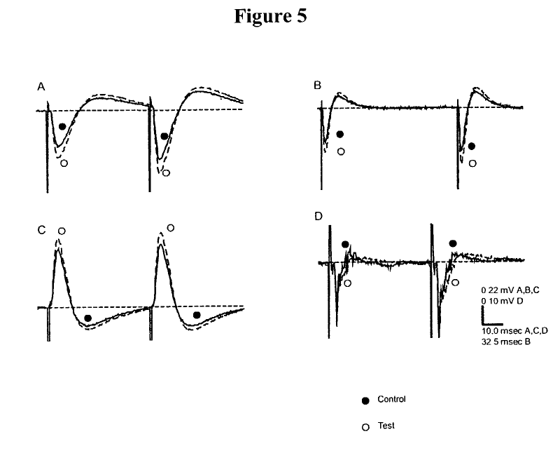

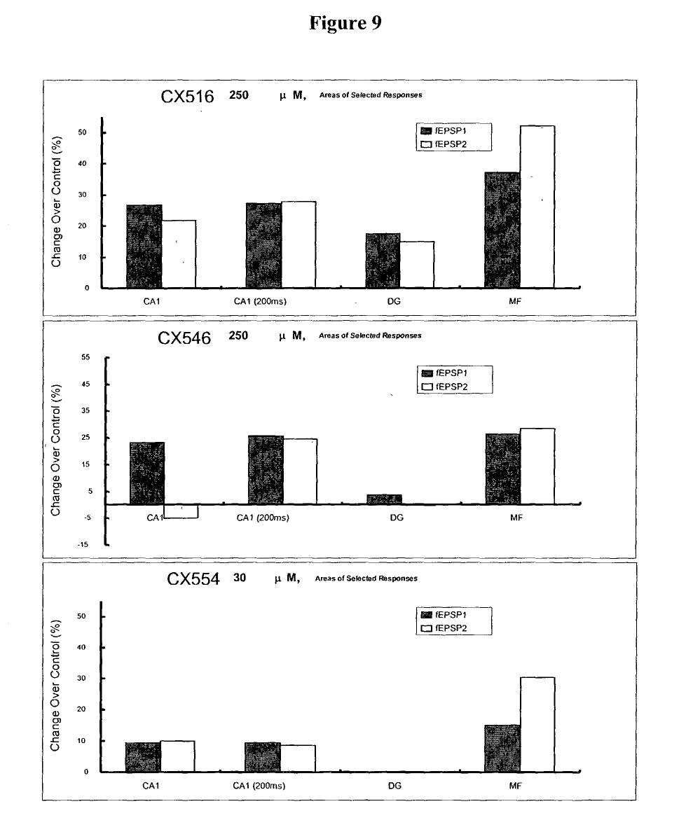

For each candidate sample composition, the effect was calculated as the ratio of the response measured under candidate sample composition application to the baseline response (control). The results are presented in Tables 1-3 and FIGS. 5-8. A summary of the findings for all the compounds in the candidate sample compositions is given in FIG. 9.

The control value was measured immediately before candidate sample application by averaging the five last responses. The effect of the compound in the candidate sample composition was calculated by averaging five responses during the last minute of a 30-minute incubation with a given candidate sample composition. Thus, each column represents a normalized change of compound action over control response. Positive and negative values represent the increase and decrease of the response during candidate sample application, respectively.

The results demonstrate that under both 50 ms and 200 ms inter-pulse delay protocols the candidate sample compositions tested produced a significant effect on glutamate receptor-mediated evoked excitatory synaptic transmission.

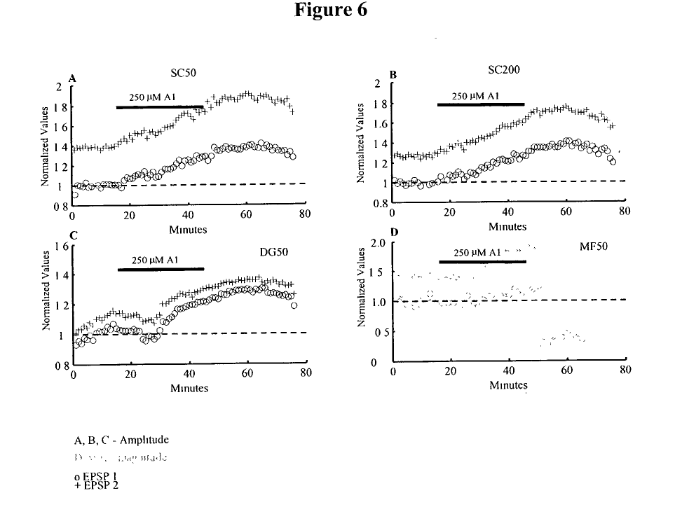

Table 1 shows that CX516 at 250 μM increased the amplitude of first and second fEPSP by 15-17% with no effect on half-width of both responses. Effects in different areas are represented in FIGS. 5 and 6.

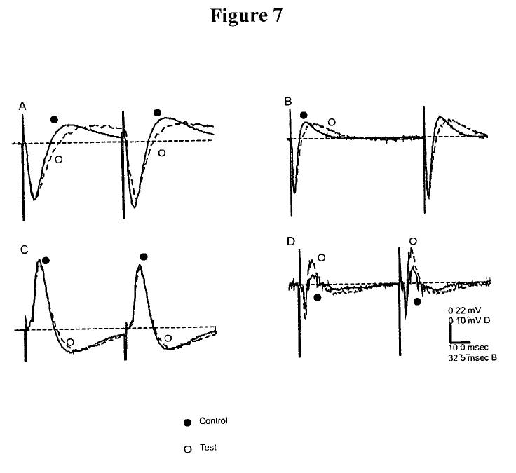

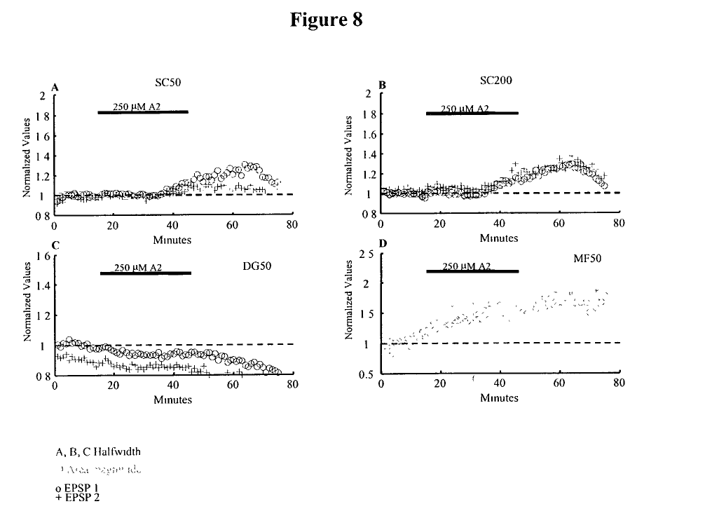

Table 2 shows that CX546 at 250 μM increased the halfwidth but not the amplitude of first and second fEPSP by 14-15% with no effect on amplitude of both responses in 200 ms protocol. However, usingthe 50 ms protocol revealed 9±3% decrease in the second response amplitude with no change of the first response. Effects in different areas are represented in FIGS. 7 and 8.

Table 3 demonstrates that CX554 at 30 μM increased the amplitude but not the half-width of both responses by 13-20%.

To compare the response of tissue slices to candidate sample compositions between different regions of the slice, the area under the curve for all 4 assays was calculated. In FIG. 9, the data from representative slices show that in CA1 and DG, the second fEPSP was potentiated less then the first fEPSP (CX546 even decreased the area of the second response in CA1). For the two compounds CX546 and CX554, the second response in DG was not noticeably altered. However, MF responses demonstrate a more dramatic effect on the second fEPSP rather than first fEPSP.

The results for 250 μM CX516 are shown in Table 1 and FIGS. 5 and 6. An increase in the amplitude of both responses was observed in CA1 with either 50 ms (A) or 200 ms (B) delay between stimulation pulses. Paired pulse stimulation with 50 ms inter-pulse delay also showed an increase in the responses recorded in dentate gyrus (C) and mossy fibers (D).

Normalized amplitude and half-width of both responses are plotted to visualize “pure” amplitude effect of the compound in CA1 stimulated with 50 ms (A) and 200 ms (B) inter-pulse delays. In dentate gyrus (C) and mossy fibers (D) the inter-pulse delay was 50 ms. For the accurate representation of the compound effect, amplitude and area of the response were measured in dentate gyrus and mossy fibers, respectively. Application of 250 μM of the compound is indicated by solid bar in each panel. Normalization was done by averaging responses in control for the first pulse and scaling all other responses with respect to this average. The results for 250 μM CX546 are shown in Table 2 and FIGS. 7 and 8.

For both responses, increase in the half-width was observed in CA1 with either 50 ms (A) or 200 ms (B) delay between stimulation pulses. Paired pulse stimulation with 50 ms inter-pulse delay also showed decrease in the amplitude for responses recorded in dentate gyrus (C) and increase of mossy fibers' response (D).

Normalized amplitude and half-width of both responses are plotted to visualize “pure” half-width effect of the compound in CA1 stimulating with 50 ms (A) and 200 ms (B) inter-pulse delays. In dentate gyrus (C) and mossy fibers (D) the inter-pulse delay was 50 ms. For the accurate representation of compound effect amplitude and area of the response were measured in dentate gyrus and mossy fibers, respectively. Application of 250 μM of the compound is indicated by solid bar in each panel. Normalization was done by averaging responses in control for the first pulse and scaling all other responses with respect to this average.

Table 3 shows the effect of 30 μM of CX554 in CA1 with 50 ms and 200 ms interpulse delays. Similarly to the cases of CX516 and CX546, results for both responses of CX554 showed an increase in the amplitude in CA1 with either 50 ms (A) or 200 ms (B) delay between stimulation pulses. Paired pulse stimulation with 50 ms inter-pulse delay also showed no noticeable change in the amplitude for responses recorded in dentate gyrus (C) and increase of mossy fibers' response (D).

Normalized amplitude and half-width of both responses are plotted to visualize “pure” amplitude effect of the compound in CA1 stimulating with 50 ms (A) and 200 ms (B) inter-pulse delays. In dentate gyrus (C) and mossy fibers (D) the inter-pulse delay was 50 ms. For the accurate representation of compound effect amplitude and area of the response were measured in dentate gyrus and mossy fibers, respectively. Application of 30 μM of the compound is indicated by solid bar in each panel. Normalization was done by averaging responses in control for the first pulse and scaling all other responses with respect to this average. The data for this compound were analyzed similarly to the cases of CX516 and CX546 and contributed to the summary shown in FIG. 9.

To compare the effect of compounds in candidate sample compositions between different regions of a tissue slice, the area under the curve for all 4 assays was calculated. In CA1 and DG, the second fEPSP was potentiated less then the first fEPSP (CX546 even decreased the area of the second response in CA1). For the two compounds CX546 and CX554, the second response in DG was not noticeably altered. However, MF responses demonstrate a more dramatic effect on the second fEPSP rather than first fEPSP.

Data Analysis

The examples described above demonstrate some of the objects and advantages of the instant invention which include: 1) using interleaving to engage multiple data gathering sites on one or more slices in a single recording chamber, thereby gathering large amounts of spatially distributed information per slice; 2) gathering data from multiple pharmacologically and anatomically distinct brain regions; 3) using such data to derive new analytical measures; 4) increasing the sensitivity with which compound effects are measured and the resolution with which compounds are discriminated; 5) predicting various properties and features of compounds (e.g., mechanisms of action, therapeutic uses, side-effects, etc.); 6) providing an enhanced level of accuracy and an enhanced internal “control” by comparing response data from pharmacologically and anatomically distinct brain regions within a given brain slice rather than between brain slices; and 7) providing a method whereby such multiple experiments can be executed in less time by using the stimulation recovery time of each site to enable the interleaving of the data gathering processes across all the sites.

The use of interleaving to engage multiple data gathering sites at the same time yields the results shown in FIGS. 6 to 9 and Tables 1 to 3. Four regions of the hippocampal slices are sampled in parallel via interleaving. FIG. 9 summarizes the results per region for each of the three compounds tested.

Gathering data from multiple hippocampal sites yields a variety of results and enables comparative analysis of site-specific effects. For a given compound in FIG. 9 there are different responses in each of the regions. Taken together, these effects represent a new kind of multi-site measurement of the effect of candidate sample compositions on tissue slices. Notice that each of the compounds yields a different pattern of responses across the various regions tested, as indicated by the changing bar heights. One can see that using four regions to characterize a compound instead of just one provides a more discriminative method for distinguishing the compounds.

The results of FIG. 9 allow us to make important predictions about drug mechanisms of action and other features. For example, ampakines can be differentiated with regard to the degree to which they enhance activation of interneurons: CX554>CX546>CX516. Additionally, because CX546 selectively increases halfwidth but not the amplitude of the responses in CA1 which is opposite to the effect of CX516 and CX554 (amplitude only modulation), the conclusion that CX546 has a different biophysical effect on the AMPA receptor than CX516 or CX554 may be made.

Although the release of glutamate after exposure of tissue slices to CX516, CX546, and CX554 is unlikely, it could also be tested using the approach described in this study.

In addition to the mechanisms of action and other predictions above, one can also treat the various regional measurements as providing a unique “signature” for a psychoactive compound. By encoding this signature in the form of a feature vector, one can then apply clustering and classification methods to discover groupings of psychoactive compounds based upon similarity measures and to predict compound side effects and therapeutic effects by comparison with compounds having known effects.

The fact that baseline electrophysiological activity and electrophysiological response activity can be measured in different regions of neuronal tissue slices during the same experiment, neuronal tissue sample health was easily preserved. Furthermore, the use of the MED64 device enabled conduction of multiple experiments in less time. For instance, in the Examples described above, 24 slices were examined. The experiments took 28 working days to complete. Using a conventional approach (one region of hippocampus is tested at a time), it is estimated that 48 slices woudl be required to achieve similar results. Accordingly,it would presumably increase the experimental time to at least 56 working days. Considering this, one may conclude that the inventive method is more efficient than conventional methods.

The instant results demonstrate that parallel, region-spanning, analysis of psychoactive compound activities can have a profound effect on the quality and type of information that can be generated from electrophysiological experiments.

As shown herein, structurally similar compounds can be differentiated with regard to the degree to which they affect regional areas within a given sample of neuronal tissue.

Such responses, and the characterization of them, provide a novel and effective detection and characterization method for psychoactive agents.

The instant invention utilizes these unexpected properties as a powerful tool for the detection and characterization of psychoactives.

All publications and patent applications cited in this application are herein incorporated by reference in their entirety. Although the foregoing invention has been described by way of illustration and example for purposes of clarity and understanding, it will be readily apparent to those of ordinary skill in the art in light of the teachings of this invention that certain changes and modifications may be made thereto without departing from the spirit or scope of the appended claims.

TABLE 1
CX516 250 μM n = 4

| | SC 50 ms | | | | SC 200 ms | | | |
|---|---|---|---|---|---|---|---|---|
| | Amplitude | | Widths | | Amplitude | | Widths | |
| fEPSP: | 1st | 2nd | 1st | 2nd | 1st | 2nd | 1st | 2nd |
| Files: | | | | | | | | |
| 010221-1-s1-A1-250 um | 0.087 | 0.044 | 0.063 | 0.045 | 0.093 | 0.067 | 0.051 | 0.049 |
| 010301-3-s1-A1-250 um | 0.110 | 0.085 | 0.007 | 0.026 | 0.114 | 0.085 | −0.002 | 0.037 |
| 010328-1-s1-A1-250 um | 0.276 | 0.246 | 0.020 | −0.001 | 0.260 | 0.258 | 0.036 | 0.035 |
| 010424-1-s1-A1-250 um | 0.211 | 0.192 | −0.023 | 0.017 | 0.206 | 0.194 | −0.024 | 0.001 |
| Mean | 0.171 | 0.142 | 0.017 | 0.022 | 0.168 | 0.151 | 0.015 | 0.031 |
| Change over Control | 17.108 | 14.178 | 1.658 | 2.168 | 16.825 | 15.088 | 1.525 | 3.055 |
| (%) | | | | | | | | |
| SEM | 4.422 | 4.665 | 1.787 | 0.954 | 3.922 | 4.549 | 1.707 | 1.033 |

TABLE 2
CX546 250 μM n = 5

| | SC 50 ms | | | | SC 200 ms | | | |
|---|---|---|---|---|---|---|---|---|
| | Amplitude | | Widths | | Amplitude | | Widths | |
| fEPSP: | 1st | 2nd | 1st | 2nd | 1st | 2nd | 1st | 2nd |
| Files: | | | | | | | | |
| 010226-1-s1-A2-250 um | −0.022 | −0.130 | 0.202 | 0.065 | −0.007 | −0.015 | 0.252 | 0.189 |
| 010226-2-s1-A2-250 um | 0.025 | −0.088 | 0.102 | 0.031 | 0.021 | 0.013 | 0.105 | 0.132 |
| 010323-1-s2-A2-250 um | 0.063 | 0.022 | 0.096 | 0.067 | 0.064 | 0.047 | 0.089 | 0.102 |
| 010412-1-s1-A2-250 um | 0.087 | −0.124 | 0.155 | 0.026 | 0.083 | 0.061 | 0.166 | 0.207 |
| 010413-1-s1-A2-250 um | 0.012 | −0.124 | 0.114 | −0.025 | 0.028 | 0.011 | 0.141 | 0.180 |
| Mean | 0.033 | −0.089 | 0.134 | 0.033 | 0.038 | 0.023 | 0.151 | 0.162 |
| Change over Control (%) | 3.296 | −8.884 | 13.386 | 3.276 | 3.764 | 2.310 | 15.064 | 16.206 |
| SEM | 1.907 | 2.861 | 1.995 | 1.663 | 1.603 | 1.369 | 2.872 | 1.937 |

TABLE 3
CX554 30 μM, n = 5

| | SC 50 ms | | | | SC 200 ms | | | |
|---|---|---|---|---|---|---|---|---|
| | Amplitude | | Widths | | Amplitude | | Widths | |
| fEPSP: | 1st | 2nd | 1st | 2nd | 1st | 2nd | 1st | 2nd |
| Files: | | | | | | | | |
| 010410-3-s1-A3-30 um | 0.117 | 0.089 | 0.070 | 0.049 | 0.111 | 0.101 | 0.093 | 0.086 |
| 010416-1-s1-A3-30 um | 0.137 | 0.139 | 0.011 | −0.012 | 0.127 | 0.120 | −0.001 | −0.003 |
| 010418-1-s1-A3-30 um | 0.477 | 0.272 | 0.122 | 0.149 | 0.474 | 0.438 | 0.089 | 0.137 |
| 010419-1-s1-A3-30 um | 0.144 | 0.033 | −0.018 | 0.003 | 0.111 | 0.100 | 0.015 | −0.025 |
| 010419-2-s1-A3-30 um | 0.184 | 0.116 | −0.013 | 0.012 | 0.188 | 0.172 | −0.008 | 0.039 |
| Mean | 0.212 | 0.130 | 0.035 | 0.040 | 0.202 | 0.186 | 0.038 | 0.047 |
| Change over Control (%) | 21.180 | 12.998 | 3.450 | 4.034 | 20.186 | 18.612 | 3.766 | 4.688 |
| SEM | 6.714 | 3.974 | 2.685 | 2.901 | 6.950 | 6.441 | 2.205 | 2.932 |

1. A process for the detection of a psychoactive compound in an in vitro neuronal tissue sample comprising:
a) comparing an electrophysiological response parameter measured simultaneously at a plurality of regions in said in vitro neuronal tissue sample contacted with a candidate sample composition with a baseline electrophysiological parameter of said regions to determine a difference between said electrophysiological response parameter and said baseline electrophysiological parameter; and
b) detecting the presence or absence of the psychoactive compound in said candidate sample composition based upon the difference between said electrophysiological response parameter and said baseline electrophysiological parameter.

2. The process of claim 1 wherein said response parameter and said baseline parameter comprise extracellular voltage.

3. The process of claim 1 wherein said response parameter and said baseline parameter comprise oscillations of extracellular potentials.

4. The process of claim 1 further comprising the step of characterizing said psychoactive compound by comparing the difference between said response parameter and said baseline parameter.

5. The process of claim 1 further comprising the step of delivering at least one timed electrical pulse to said in vitro neuronal tissue sample.

6. The process of claim 5 wherein said at least one timed electrical pulse is delivered to one or more of said regions in the in vitro neuronal tissue sample.

7. The process of claim 1 wherein said baseline electrophysiological parameter is induced by a chemical composition.

8. The process of claim 7 wherein the said chemical composition mimics the actions of a neurotransmitter.

9. The process of claim 8 wherein said chemical composition mimics the actions of a neurotransmitter selected from the group consisting of acetylcholine, other cholinomimetics, catecholamines, dopamine, GABA, glutamine, nitric oxide, opioids, and serotonin.

10. The process of claim 9 wherein said neurotransmitter is a cholinomimetic.

11. The process of claim 7 wherein said chemical composition is a stimulating composition.

12. The process of claim 1 wherein said baseline electrophysiological parameter is induced by electrical stimulation.

13. The process of claim 1 wherein said baseline electrophysiological parameter is induced by co-deposited neuronal tissue.

14. A device for the detection and characterization of a psychoactive compound in an in vitro neuronal tissue sample comprising:
a) a stimulation chamber comprising a cell potential measuring electrode array having a plurality of measurement microelectrodes located on an insulating substrate, said microelectrodes adapted to detect an electrophysiological response parameter of said in vitro neuronal tissue sample;
b) a plurality of reference electrodes located on said insulating substrate;
c) an amplifier connected to said stimulation chamber; and
d) a computer connected to said amplifier, wherein said computer includes software for i.) simultaneously detecting a plurality of electrophysiological response parameters in said in vitro neuronal tissue sample both before and after contacting a psychoactive compound candidate sample composition to said in vitro neuronal tissue sample; ii.) comparing said before and after electrophysiological response parameters to detect the presence or absence of a psychoactive compound and, if detected, to characterize said psychoactive compound based upon differences between said before and after electrophysiological response parameters.

15. The device of claim 14 wherein said computer further comprises software that pre-programs and executes the delivery of a timed electrical stimulation pulse and electrode switching patterns.

16. The device of claim 14 wherein said array comprises 64 microelectrodes disposed in eight rows and eight columns at central pitches of 100 to 450 micrometers.

17. The device of claim 14 wherein a wall encloses said measuring microelectrodes.

18. The device of claim 14 wherein said measuring microelectrodes and reference electrodes are formed by layering nickel plating, gold plating, and platinum black on an indium-tin oxide film.

19. The device of claim 14 wherein said measuring microelectrodes and reference electrodes are glass electrodes.

20. A device for detecting and characterizing a psychoactive compound in an in vitro neuronal tissue sample comprising:
a) a stimulation chamber comprising a cell potential measuring electrode array having a plurality of measurement microelectrodes located on an insulating substrate, said microelectrodes adapted to detect an electrophysiological response parameter of said in vitro neuronal tissue sample subjected to a timed electrical pulse;
b) a conductive pattern for wiring of said microelectrodes;
c) an electric contact connected to an end of said conductive pattern;
d) an insulating film covering a surface of said conductive pattern; and
e) a wall enclosing said region including the microelectrodes on said surface of said insulating film;
f) an amplifier connected to said stimulation chamber; and
f) a computer connected to said amplifier, wherein said computer includes software for i.) simultaneously detecting a plurality of electrophysiological response parameters in said in vitro neuronal tissue sample both before and after contacting a psychoactive compound candidate sample composition to said in vitro neuronal tissue sample; ii.) comparing said before and after electrophysiological response parameters to detect the presence or absence of a psychoactive compound and, if detected, to characterize said psychoactive compound based upon differences between said before and after electrophysiological response parameters.

21. The device of claim 20 wherein said array comprises 64 microelectrodes disposed in eight rows and eight columns at central pitches of 100 to 450 micrometers.

22. A method for the detection and characterization of a psychoactive compound in an in vitro neuronal tissue sample comprising the steps of:
a) simultaneously measuring a baseline electrophysiological parameter at a plurality of regions in the in vitro neuronal tissue sample;
b) contacting the in vitro neuronal tissue sample with a candidate sample composition;
c) measuring a resulting electrophysiologial response parameter in the in vitro neuronal tissue sample; and
d) comparing the resulting electrophysiological response parameter with the baseline electrophysiological parameter to detect the presence or absence of said psychoactive compound in said candidate sample composition.

23. The method of claim 22 wherein said characterizing step further comprises providing a signature for said detected psychoactive compound.

24. The method of claim 22 further comprising the step of delivering at least one timed electrical pulse to said in vitro neuronal tissue sample.

25. The method of claim 24 wherein said at least one timed electrical pulse is delivered to one or more regions of said in vitro neuronal tissue sample.

26. The method of claim 22 further comprising the step of adding a chemical composition to said in vitro neuronal tissue sample prior to measurement of said baseline electrophysiological parameter.

27. The method of claim 26 wherein said chemical composition mimics the actions of a neurotransmitter.

28. The method of claim 27 wherein said chemical composition mimics the actions of a neurotransmitter selected from the group consisting of acetylcholine, other cholinomimetics, catecholamines, dopamine, GABA, glutamine, nitric oxide, opioids, and serotonin.

29. The method of claim 28 wherein said chemical composition comprises a cholinomimetic compound.

30. The method of claim 26 wherein said chemical composition is a stimulating composition.

31. The method of claim 22 further comprising the step of co-depositing neuronal tissue with said in vitro neuronal tissue sample prior to measurement of said baseline electrophysiological parameter.

32. The method of claim 22 further comprising the step of delivering an electrical stimulation to said in vitro neuronal tissue sample prior to measurement of said baseline electrophysiological parameter.

33. A method for the detection and characterization of a psychoactive compound in a plurality of in vitro neuronal tissue samples comprising the steps of:
a) simultaneously measuring a baseline electrophysiological parameter at a plurality of regions in the in vitro neuronal tissue samples;
b) contacting the in vitro neuronal tissue samples with a candidate sample composition;
c) measuring a resulting electrophysiologial response parameter in the in vitro neuronal tissue samples; and
d) comparing the resulting electrophysiological response parameter with the baseline electrophysiological parameter to detect the presence or absence of said psychoactive compound in said candidate sample composition.
